(19) United States
(12) Patent Application Publication
(10) Pub. No.: US 2009/0113308 A1
(43) Pub. Date: Apr. 30, 2009

(54) Administering Communications Schedules for Data Communications Among Compute Nodes in a Data Communications Network of a Parallel Computer

(76) Inventors: Gheorghe Almasi, Ardsley, NY (US); Charles J. Archer, Rochester, MN (US); Charles C. Erway, Providence, RI (US); Brian E. Smith, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/924,934

(22) Filed: Oct. 26, 2007

(51) Int. Cl. G06F 17/00; G06F 3/048

(52) U.S. Cl. 715/734; 715/273

(57) ABSTRACT

Methods, apparatus, and products are disclosed for creating and administering communications schedules for data communications among compute nodes in a data communications network of a parallel computer that include: receiving a communications schedule specifying data communications steps in a message passing operation performed by the compute nodes in the data communications network of the parallel computer; parsing the communications schedule to identify the data communications steps; and generating a graphical representation of the communications schedule, including graphing the data communications steps for the message passing operation.

### STATEMENT REGARDING FEDERALLY SPONSORED RESEARCH OR DEVELOPMENT

This invention was made with Government support under Contract No. B554331 awarded by the Department of Energy. The Government has certain rights in this invention.

### BACKGROUND OF THE INVENTION

1. Field of the Invention

The field of the invention is data processing, or, more specifically, methods, apparatus, and products for administering communications schedules for data communications among compute nodes in a data communications network of a parallel computer.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory operations or message passing operations. Shared memory processing needs additional locking for the data and imposes the overhead of additional processor and bus cycles and also serializes some portion of the algorithm.

Message passing operations use high-speed data communications networks and message buffers, but this communication adds transfer overhead on the data communications networks as well as additional memory needed for message buffers and latency in the data communications among nodes. Designs of parallel computers use specially designed data communications links so that the communication overhead will be small but it is the parallel algorithm that typically decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x, y, z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

As mentioned above, compute nodes in such data communications networks often communicate through message passing operations such as, for example, a broadcast operation. A broadcast operation instructs a broadcasting compute node to distribute data from the broadcasting compute node to all the other compute nodes in a group. Message passing operations, such as the broadcast operation, are typically performed by each compute node according to a communications schedule. The communications schedule specifies the data communications steps in a message passing operation performed by the compute nodes in the data communications network of the parallel computer. In a broadcast operation, for example, the communications schedule specifies the links along which the broadcasting compute node sends data, and in turn, specifies the links along which those receiving the data should forward the data. Because thousands of nodes may participate in a message passing operation, designing and administering the communications schedule for a message passing operation is always a challenge. As such, readers will appreciate that room for improvement exists in creating and administering communications schedules for data communications among compute nodes in a data communications network of a parallel computer.

### SUMMARY OF THE INVENTION

Methods, apparatus, and products are disclosed for creating and administering communications schedules for data communications among compute nodes in a data communications network of a parallel computer that include: receiving a communications schedule specifying data communications steps in a message passing operation performed by the compute nodes in the data communications network of the parallel computer; parsing the communications schedule to identify the data communications steps; and generating a graphical representation of the communications schedule, including graphing the data communications steps for the message passing operation.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary parallel computer for creating and administering communications schedules for data communications among compute nodes in a data communications network of the parallel computer according to embodiments of the present invention.

FIG. 2 sets forth a block diagram of an exemplary compute node useful in a parallel computer capable of creating and administering communications schedules for data communications among compute nodes in a data communications network of the parallel computer according to embodiments of the present invention.

FIG. 3A illustrates an exemplary Point To Point Adapter useful in a parallel computer capable of creating and administering communications schedules for data communications among compute nodes in a data communications network of the parallel computer according to embodiments of the present invention.

FIG. 3B illustrates an exemplary Global Combining Network Adapter useful in a parallel computer capable of creating and administering communications schedules for data communications among compute nodes in a data communications network of the parallel computer according to embodiments of the present invention.

FIG. 4 sets forth a line drawing illustrating an exemplary data communications network optimized for point to point operations useful in a parallel computer capable of creating and administering communications schedules for data communications among compute nodes in a data communications network of the parallel computer according to embodiments of the present invention.

FIG. 5 sets forth a line drawing illustrating an exemplary data communications network optimized for collective operations useful in a parallel computer capable of creating and administering communications schedules for data communications among compute nodes in a data communications network of the parallel computer according to embodiments of the present invention.

FIG. 6 sets forth a flow chart illustrating an exemplary method for administering communications schedules for data communications among compute nodes in a data communications network of a parallel computer according to embodiments of the present invention.

FIG. 7 sets forth a flow chart illustrating a further exemplary method for administering communications schedules for data communications among compute nodes in a data communications network of a parallel computer according to embodiments of the present invention.

FIG. 8 sets forth a flow chart illustrating an exemplary method for creating communications schedules for data communications among compute nodes in a data communications network of a parallel computer according to embodiments of the present invention.

FIG. 9 sets forth a flow chart illustrating a further exemplary method for administering communications schedules for data communications among compute nodes in a data communications network of a parallel computer according to embodiments of the present invention.

### DETAILED DESCRIPTION OF EXEMPLARY EMBODIMENTS

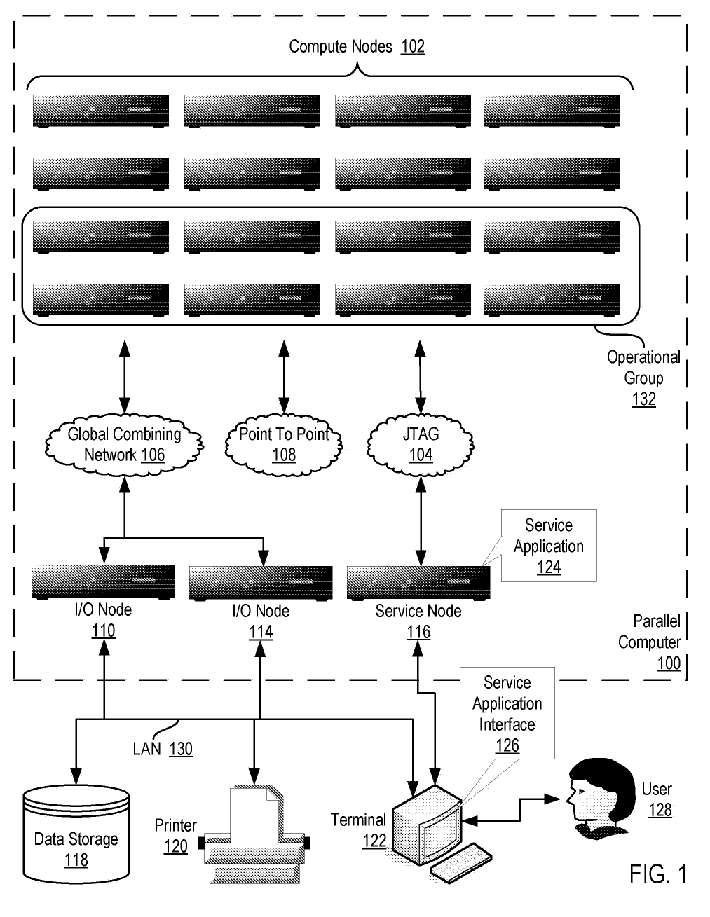

Exemplary methods, apparatus, and computer program products for creating and administering communications schedules for data communications among compute nodes in a data communications network of a parallel computer according to embodiments of the present invention are described with reference to the accompanying drawings, beginning with FIG. 1. FIG. 1 illustrates an exemplary parallel computer for administering communications schedules for data communications among compute nodes in a data communications network of the parallel computer according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102).

The compute nodes (102) are coupled for data communications by several independent data communications networks including a Joint Test Action Group (‘JTAG’) network (104), a global combining network (106) which is optimized for collective operations, and a torus network (108) which is optimized point to point operations. The global combining network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer. The links between compute nodes are bi-directional links that are typically implemented using two separate directional data communications paths.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operation for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for use with systems according to embodiments of the present invention include MPI and the ‘Parallel Virtual Machine’ (‘PVM’) library. PVM was developed by the University of Tennessee, The Oak Ridge National Laboratory, and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group. For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

In a scatter operation, the logical root divides data on the root into segments and distributes a different segment to each compute node in the operational group. In scatter operation, all processes typically specify the same receive count. The send arguments are only significant to the root process, whose buffer actually contains sendcount * N elements of a given data type, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, the parallel computer (100) includes input/output (‘I/O’) nodes (110, 114) coupled to compute nodes (102) through the global combining network (106). The compute nodes in the parallel computer (100) are partitioned into processing sets such that each compute node in a processing set is connected for data communications to the same I/O node. Each processing set, therefore, is composed of one I/O node and a subset of compute nodes (102). The ratio between the number of compute nodes to the number of I/O nodes in the entire system typically depends on the hardware configuration for the parallel computer. For example, in some configurations, each processing set may be composed of eight compute nodes and one I/O node. In some other configurations, each processing set may be composed of sixty-four compute nodes and one I/O node. Such example are for explanation only, however, and not for limitation. Each I/O nodes provide I/O services between compute nodes (102) of its processing set and a set of I/O devices. In the example of FIG. 1, the I/O nodes (110, 114) are connected for data communications I/O devices (118, 120, 122) through local area network (‘LAN’) (130) implemented using high-speed Ethernet.

The parallel computer (100) of FIG. 1 also includes a service node (116) coupled to the compute nodes through one of the networks (104). Service node (116) provides services common to pluralities of compute nodes, administering the configuration of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122). The service application interface (126) provides to the users (128) a user interface with which to interact with the service application (124).

As described in more detail below in this specification, the service application (124) of FIG. 1 includes computer program instructions for creating and administering communications schedules for data communications among compute nodes in a data communications network of a parallel computer according to embodiments of the present invention. The service application (124) operates generally for administering communications schedules for data communications among compute nodes in a data communications network of a parallel computer according to embodiments of the present invention by: receiving a communications schedule specifying data communications steps in a message passing operation performed by the compute nodes in the data communications network of the parallel computer; parsing the communications schedule to identify the data communications steps; and generating a graphical representation of the communications schedule, including graphing the data communications steps for the message passing operation. The service application (124) and the service application interface (126) of FIG. 1 operate generally for creating communications schedules for data communications among compute nodes in a data communications network of a parallel computer according to embodiments of the present invention by: receiving, from a user through a graphical user interface, a graphical representation of a message passing operation, the graphical representation specifying data communications steps in a message passing operation performed by the compute nodes in the data communications network of the parallel computer; and generating a communications schedule in dependence upon the graphical representation and communications schedule generation rules.

The arrangement of nodes, networks, and I/O devices making up the exemplary system illustrated in FIG. 1 are for explanation only, not for limitation of the present invention. Data processing systems capable of creating and administering communications schedules for data communications among compute nodes in a data communications network of a parallel computer according to embodiments of the present invention may include additional nodes, networks, devices, and architectures, not shown in FIG. 1, as will occur to those of skill in the art. Although the parallel computer (100) in the example of FIG. 1 includes sixteen compute nodes (102), readers will note that parallel computers capable of determining when a set of compute nodes participating in a barrier operation are ready to exit the barrier operation according to embodiments of the present invention may include any number of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1.

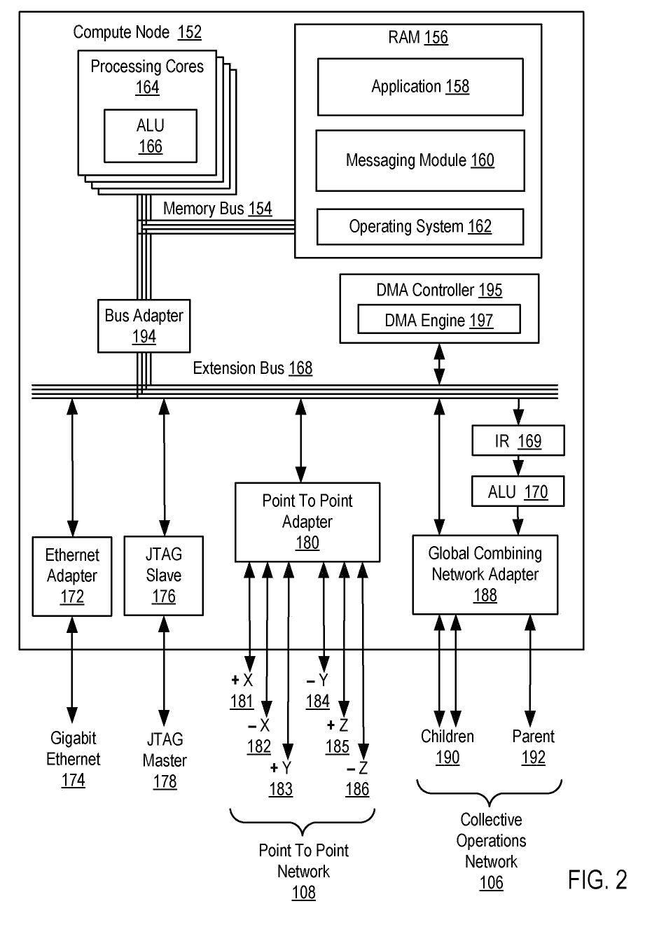

Creating and administering communications schedules for data communications among compute nodes in a data communications network of a parallel computer according to embodiments of the present invention may be generally implemented on a parallel computer that includes a plurality of compute nodes. In fact, such computers may include thousands of such compute nodes. Each compute node is in turn itself a kind of computer composed of one or more computer processors (or processing cores), its own computer memory, and its own input/output adapters. For further explanation, therefore, FIG. 2 sets forth a block diagram of an exemplary compute node useful in a parallel computer capable of creating and administering communications schedules for data communications among compute nodes in a data communications network of the parallel computer according to embodiments of the present invention. The compute node (152) of FIG. 2 includes one or more processing cores (164) as well as random access memory (‘RAM’) (156). The processing cores (164) are connected to RAM (156) through a high-speed memory bus (154) and through a bus adapter (194) and an extension bus (168) to other components of the compute node (152). Stored in RAM (156) is an application (158), a module of computer program instructions that carries out parallel, user-level data processing using parallel algorithms.

Also stored in RAM (156) is a messaging module (160), a library of computer program instructions that carry out parallel communications among compute nodes, including point to point operations as well as collective operations. Application (158) executes point to point and collective operations by calling software routines in the messaging module (160). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful in systems for creating and administering communications schedules for data communications among compute nodes in a data communications network of a parallel computer according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in administering communications schedules for data communications among compute nodes in a data communications network of a parallel computer according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Global Combining Network Adapter (188) that couples example compute node (152) for data communications to a network (106) that is optimal for collective message passing operations on a global combining network configured, for example, as a binary tree. The Global Combining Network Adapter (188) provides data communications through three bidirectional links: two to children nodes (190) and one to a parent node (192).

Example compute node (152) includes two arithmetic logic units (‘ALUs’). ALU (166) is a component of each processing core (164), and a separate ALU (170) is dedicated to the exclusive use of Global Combining Network Adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, Global Combining Network Adapter (188) may execute the arithmetic or logical operation by use of ALU (166) in processor (164) or, typically much faster, by use dedicated ALU (170).

The example compute node (152) of FIG. 2 includes a direct memory access (‘DMA’) controller (195), which is computer hardware for direct memory access and a DMA engine (197), which is computer software for direct memory access. In the example of FIG. 2, the DMA engine (197) is configured in computer memory of the DMA controller (195). Direct memory access includes reading and writing to memory of compute nodes with reduced operational burden on the central processing units (164). A DMA transfer essentially copies a block of memory from one location to another, typically from one compute node to another. While the CPU may initiate the DMA transfer, the CPU does not execute it.

As mentioned above, the exemplary compute node (152) of FIG. 2 is useful in a parallel computer capable of creating and administering communications schedules for data communications among compute nodes in a data communications network of the parallel computer according to embodiments of the present invention. The parallel computer in such an embodiment typically includes a service node similar to the compute node (152) of FIG. 2. That is, the service node includes processing cores, RAM, buses, network adapters, and so on, that all operate in a manner similar to that described above with reference to the compute node (152) of FIG. 2. The service node in such an embodiment is configured with computer program instructions stored in RAM capable of administering communications schedules for data communications among compute nodes in a data communications network of the parallel computer according to embodiments of the present invention by: receiving a communications schedule specifying data communications steps in a message passing operation performed by the compute nodes in the data communications network of the parallel computer; parsing the communications schedule to identify the data communications steps; and generating a graphical representation of the communications schedule, including graphing the data communications steps for the message passing operation.

The service node in such an embodiment is configured with computer program instructions stored in RAM capable of creating communications schedules for data communications among compute nodes in a data communications network of the parallel computer according to embodiments of the present invention by: receiving, from a user through a graphical user interface, a graphical representation of a message passing operation, the graphical representation specifying data communications steps in a message passing operation performed by the compute nodes in the data communications network of the parallel computer; and generating a communications schedule in dependence upon the graphical representation and communications schedule generation rules

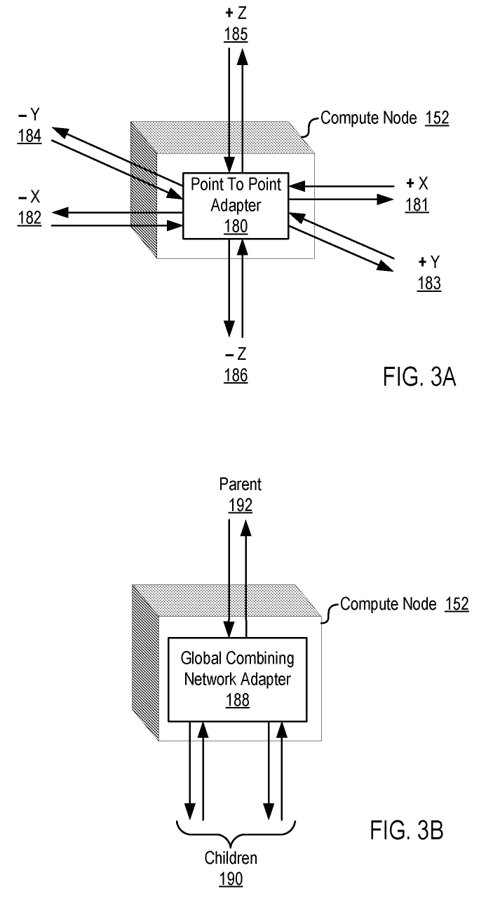

For further explanation, FIG. 3A illustrates an exemplary Point To Point Adapter (180) useful in a parallel computer capable of creating and administering communications schedules for data communications among compute nodes in a data communications network of the parallel computer according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in FIG. 3A also provides data communication along a z-axis through four unidirectional data communications links, to and from the next node in the −z direction (186) and to and from the next node in the +z direction (185).

For further explanation, FIG. 3B illustrates an exemplary Global Combining Network Adapter (188) useful in a parallel computer capable of creating and administering communications schedules for data communications among compute nodes in a data communications network of the parallel computer according to embodiments of the present invention. Global Combining Network Adapter (188) is designed for use in a network optimized for collective operations, a network that organizes compute nodes of a parallel computer in a binary tree. Global Combining Network Adapter (188) in the example of FIG. 3B provides data communication to and from two children nodes (190) through two links. Each link to each child node (190) is formed from two unidirectional data communications paths. Global Combining Network Adapter (188) also provides data communication to and from a parent node (192) through a link form from two unidirectional data communications paths.

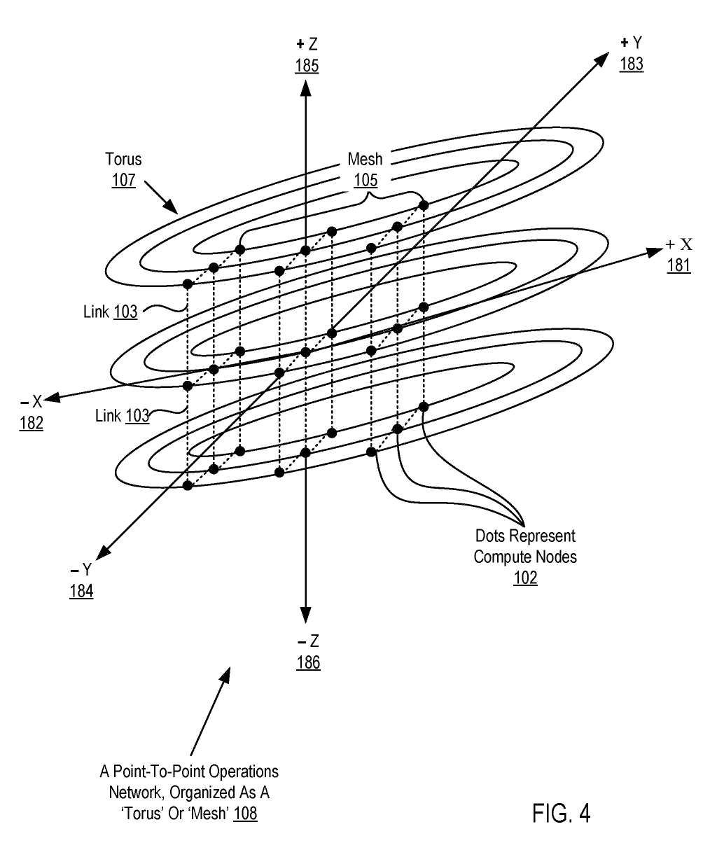

For further explanation, FIG. 4 sets forth a line drawing illustrating an exemplary data communications network (108) optimized for point to point operations useful in a parallel computer capable of creating and administering communications schedules for data communications among compute nodes in a data communications network of the parallel computer in accordance with embodiments of the present invention. In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105). The mesh (105) has wrap-around links on each axis that connect the outermost compute nodes in the mesh (105) on opposite sides of the mesh (105). These wrap-around links form part of a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point to point operations for use in administering communications schedules for data communications among compute nodes in a data communications network of a parallel computer in accordance with embodiments of the present invention may contain only a few compute nodes or may contain thousands of compute nodes.

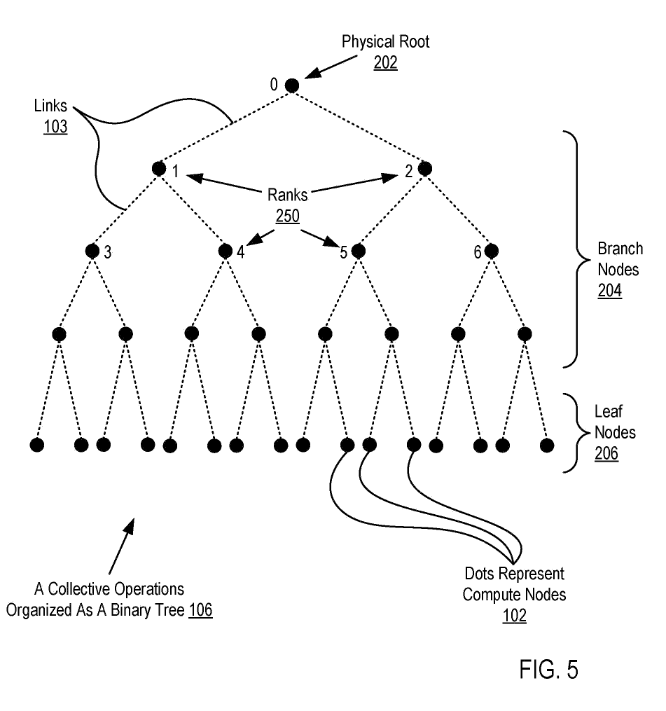

For further explanation, FIG. 5 sets forth a line drawing illustrating an exemplary data communications network (106) optimized for collective operations useful in a parallel computer capable of creating and administering communications schedules for data communications among compute nodes in a data communications network of the parallel computer in accordance with embodiments of the present invention. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in a binary tree (106) may be characterized as a physical root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a data communications network optimized for collective operations for use in a parallel computer for creating and administering communications schedules for data communications among compute nodes in a data communications network of the parallel computer accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

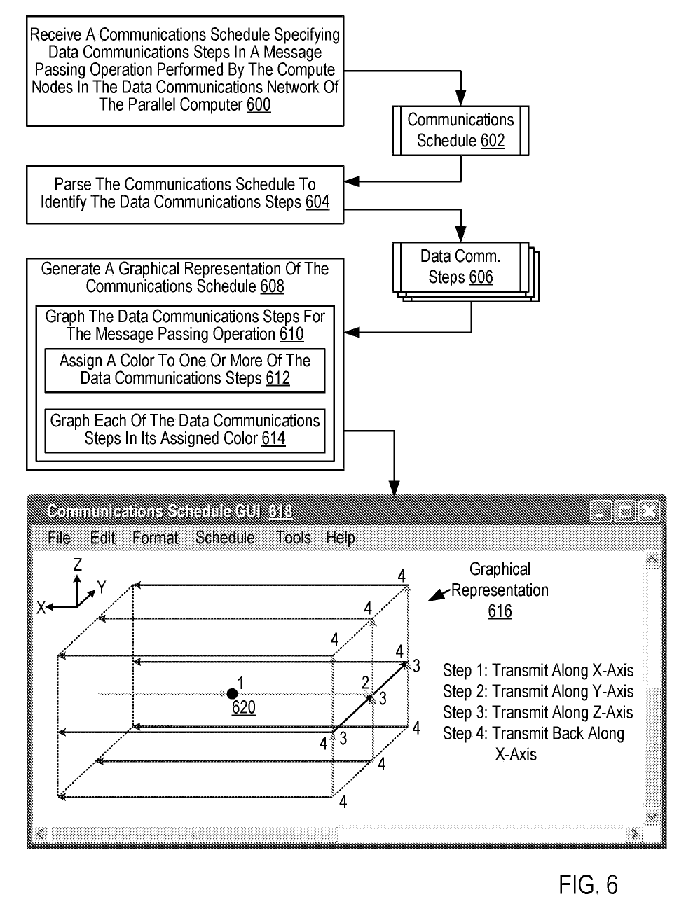

For further explanation, FIG. 6 sets forth a flow chart illustrating an exemplary method for administering communications schedules for data communications among compute nodes in a data communications network of a parallel computer according to embodiments of the present invention. As mentioned above, administering communications schedules for data communications among compute nodes in a data communications network of a parallel computer according to the method of FIG. 6 may be carried out on a service node of the parallel computer. Readers will note, however, that such an example is for explanation only. Any computing device having access to the network topology of the data communications network in the parallel computer may also be useful in administering communications schedules for data communications among compute nodes in a data communications network of a parallel computer according to the method of FIG. 6. Such a network topology may be represented using, for example, the Graph Description Language (‘GDL’), the eXtensible Graph Markup and Modeling Language (‘XGMML’), C++ objects, C objects, Java objects, and so on.

The method of FIG. 6 includes receiving (600) a communications schedule (602). A communications schedule specifies data communications steps in a message passing operation performed by the compute nodes in the data communications network of the parallel computer. Each of the data communications steps is a set of instructions that instruct the compute nodes in a data communications network how to perform the particular step of the message passing operation. Receiving (600) a communications schedule (602) according to the method of FIG. 6 may be carried out by receiving a user selection through a graphical user interface (‘GUI’) identifying the communications schedule (602) contained in computer storage and retrieving the communications schedule (602) from the computer storage. In other embodiments, receiving (600) a communications schedule (602) according to the method of FIG. 6 may be carried out by receiving a message from a software application through a communications channel that encapsulates the communications schedule (602). Such an application may be a source code editor in a software development environment that a user uses to manually input text to create a communications schedule.

For further explanation of a communications schedule, consider the follow description of a communications schedule for performing a broadcast operation in a data communication network having a torus network topology:
Step 1: Flow data from the broadcasting node to all the nodes along an X-axis for the broadcasting node.
Step 2: Flow data from the node along the X-axis for the broadcasting node and having a value of ‘0’ for the X-coordinate to all the nodes along a Y-axis for that node.
Step 3: Flow data from each node having a value of ‘0’ for their X-coordinate and having the same value for their Z-coordinate as the broadcasting node to all the nodes along a Z-axis for that node.
Step 4: Flow data from each node having a value of ‘0’ for their X-coordinate, except the node along the X-axis for the broadcasting node, to all the nodes along an X-axis for that node.

Readers will note that each step in the communications schedule is typically implemented in a high-level programming language that is compiled before being executed by the individual compute nodes. Such programming languages may include, for example, C, C++, FORTRAN, assembly language, and so on. Other implementations of a communications schedule, however, may be implemented in machine-readable binary code that does not require compilation before execution on the compute nodes.

The method of FIG. 6 also includes parsing (604) the communications schedule (602) to identify the data communications steps (606). As mentioned above, each of the data communications steps (606) represents a set of instructions that instruct the compute nodes in a data communications network how to perform the particular step of the message passing operation. In some embodiments, the beginning and end of each step may be identified in the communications schedule (602) using a start tag and an end tag. In such embodiments, parsing (604) the communications schedule (602) to identify the data communications steps (606) according to the method of FIG. 6, may be carried out by traversing through the communications schedule (602) to locate the start tag and the end tag for each step. In other embodiments, parsing (604) the communications schedule (602) to identify the data communications steps (606) according to the method of FIG. 6 may be carried out by traversing through the communications schedule (602) to locate data communication steps (606) using a set step identification rules. Such step identification rules may associate the steps of a message passing operation with patterns of text used in each step.

The method of FIG. 6 also includes generating (608) a graphical representation (616) of the communications schedule (602). Generating (608) a graphical representation (616) of the communications schedule (602) according to the method of FIG. 6 may be carried out by rendering the graphical representation (616) on a graphical user interface (‘GUI’). In the example of FIG. 6, the graphical representation (616) is rendered on a communications schedule GUI (618).

Generating (608) a graphical representation (616) of the communications schedule (602) according to the method of FIG. 6 may be carried out by graphing (610) the data communications steps (606) for the message passing operation. Graphing (610) the data communications steps (606) for the message passing operation according to the method of FIG. 6 may be carried out by identifying the flow of data among the nodes for each data communication step (606) and rendering the flow of data among the nodes using arrows. In the method of FIG. 6, graphing (610) the data communications steps (606) for the message passing operation according to the method of FIG. 6 also includes assigning (612) a color to one or more of the data communications steps (606) and graphing (614) each of the data communications steps (606) in its assigned color.

For further explanation, consider the exemplary graphical representation (616) in the example of FIG. 6. The exemplary graphical representation (616) of FIG. 6 illustrates a graphical representation of the exemplary communications schedule above for a broadcast operation in a torus network. The exemplary graphical representation (616) of FIG. 6 illustrates the torus network as a rectangular box. The links and nodes, except for the broadcasting node (620) are omitted for clarity. Wrap-around links between opposite faces of the rectangular box are also omitted for clarity. As mentioned above, the first data communications step flows data from the broadcasting node (620) to all the nodes along an X-axis for the broadcasting node (620). The graphical representation (616) of FIG. 6 illustrates that the first data communications step takes place on the broadcast node (620) using the numeral ‘1.’ The first data communication step is represented in FIG. 6 as an arrow from the broadcast node (620) along the X-axis for the broadcast node (620) to the node having a value of ‘0’ for its X-coordinate on the right end of the rectangular box. At the right end of the rectangular box, the data wraps around to the left end of the rectangular box. As such, the first data communication step is also represented in FIG. 6 as an arrow from the node having a value of ‘0’ for its X-coordinate on the left end of the rectangular box to the broadcast node (620) along the X-axis for the broadcast node (620).

The second data communications step flows data from the node along the X-axis for the broadcasting node (620) having a value of ‘0’ for the X-coordinate to all the nodes along a Y-axis for that node. The graphical representation (616) of FIG. 6 illustrates the node on which the second data communications step takes place using the numeral ‘2.’ The second data communication step is represented in FIG. 6 as an arrow from the node along the X-axis for the broadcasting node (620) having a value of ‘0’ for the X-coordinate along the Y-axis for that node to the node at the far end of the rectangular box. At the far end of the rectangular box, the data wraps around to the near end of the rectangular box. As such, the second data communication step is also represented in FIG. 6 as an arrow to the node along the X-axis for the broadcasting node (620) having a value of ‘0’ for the X-coordinate along the Y-axis for that node from the node at the near end of the rectangular box.

The third data communications step flows data from each node having a value of ‘0’ for their X-coordinate and having the same value for their Z-coordinate as the broadcasting node (620) to all the nodes along a Z-axis for that node. The graphical representation (616) of FIG. 6 illustrates the nodes on which the third data communications step takes place using the numeral ‘3.’ The third data communication step is represented in FIG. 6 as an arrow along the Z-axis from each node having a value of ‘0’ for their X-coordinate and having the same value for their Z-coordinate as the broadcasting node (620) to the node at the top end of the rectangular box. At the top end of the rectangular box, the data wraps around to the bottom end of the rectangular box. As such, the third data communication step is also represented in FIG. 6 as an arrow along the Z-axis to each node having a value of ‘0’ for their X-coordinate and having the same value for their Z-coordinate as the broadcasting node (620) from the node at the bottom end of the rectangular box.

The fourth data communications step flows data from each node having a value of ‘0’ for their X-coordinate, except the node along the X-axis for the broadcasting node, to all the nodes along an X-axis for that node. The graphical representation (616) of FIG. 6 illustrates the nodes on which the fourth data communications step takes place using the numeral ‘4.’ The fourth data communication step is represented in FIG. 6 as an arrow along an X-axis from each node having a value of ‘0’ for their X-coordinate, except the node along the X-axis for the broadcasting node, to the node at the left end of the rectangular box.

Readers will note that the graphical representation (616) of FIG. 6 advantageously provides a visual representation of a communications schedule for a broadcast operation. The graphical representation (616) of FIG. 6 allows schedule designers to easily determine whether a particular communications schedule enables the compute nodes in a data communications network to correctly perform a particular message passing operation such as, for example, a broadcast operation.

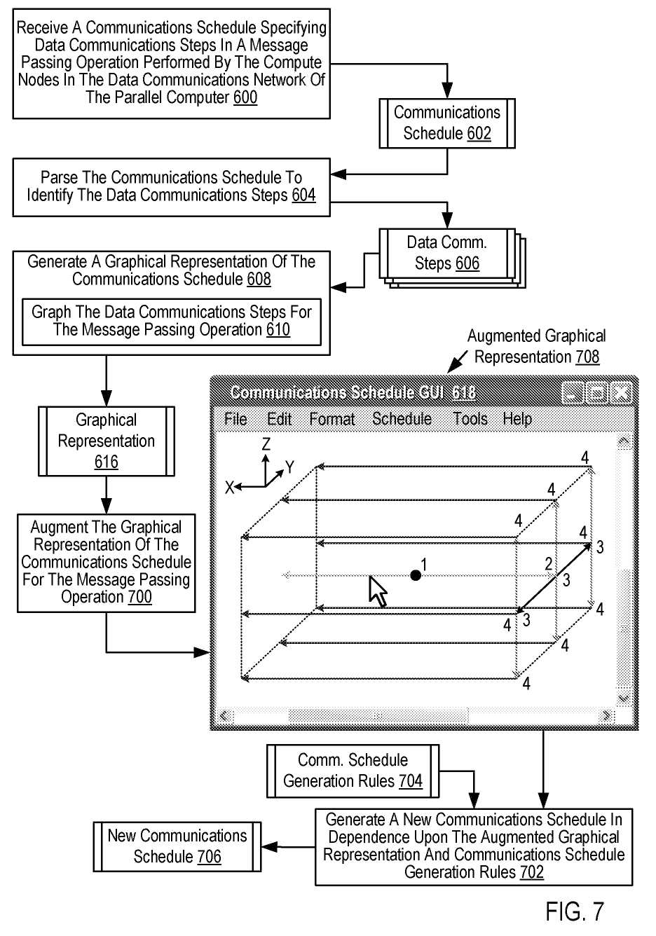

After generating a graphical representation of a communications schedule, a user may desire to augment the graphical representation in some way and generate a new communications schedule. For further explanation, FIG. 7 sets forth a flow chart illustrating a further exemplary method for administering communications schedules for data communications among compute nodes in a data communications network of a parallel computer according to embodiments of the present invention.

The method of FIG. 7 is similar to the method of FIG. 6. That is, the method of FIG. 7 includes: receiving (600) a communications schedule (602) specifying data communications steps (606) in a message passing operation performed by the compute nodes in the data communications network of the parallel computer; parsing (604) the communications schedule (602) to identify the data communications steps (606); and generating (608) a graphical representation (616) of the communications schedule (602), including graphing (610) the data communications steps (606) for the message passing operation.

The method of FIG. 7 also includes augmenting (700) the graphical representation (616) of the communications schedule (602) for the message passing operation. Augmenting (700) the graphical representation (616) of the communications schedule (602) for the message passing operation according to the method of FIG. 7 may be carried out by receiving user input that modifies the graphical representation (616). The user may provide such input through a variety of user input devices as will occur to those of skill in the art, including a keyboard, mouse, touch-screen, microphone, and so on. FIG. 7 illustrates an augmented graphical representation (708) that is augmented from the graphical representation (616) in FIG. 6 of the communications schedule (602) for a broadcast operation in a torus network. In FIG. 7, user input is received to alter the graphical representation from a communications schedule for a broadcast operation in a torus network to a rectangular mesh. Specifically, the graphical representation (616) is augmented to effect a broadcast operation even when the wrap-around links for the torus are removed from the data communications network.

The method of FIG. 7 also includes generating (702) a new communications schedule (706) in dependence upon the augmented graphical representation (708) and communications schedule generation rules (704). The communications schedule generation rules (704) of FIG. 7 represent a set of rules used to transform a graphical representation of the data flows for a message passing operation into a communications schedule capable of being executed by or compiled for execution by the compute nodes in a data communications network. Generating (702) a new communications schedule (706) according to the method of FIG. 7 may be carried out by applying the communications schedule generation rules (704) to the augmented graphical representation (708) and storing the output as the new communications schedule (706).

For further explanation, consider the augmented graphical representation (708) in FIG. 7. Applying the communications schedule generation rules (704) to the augmented graphical representation (708) may produce an exemplary new communications schedule (706) that is described as follows:
Step 1: Flow data from the broadcasting node to all the nodes along an X-axis for the broadcasting node in both the positive and negative directions.
Step 2: Flow data from the node along the X-axis for the broadcasting node and having a value of ‘0’ for the X-coordinate to all the nodes along a Y-axis for that node in both the positive and negative directions.
Step 3: Flow data from each node having a value of ‘0’ for their X-coordinate and having the same value for their Z-coordinate as the broadcasting node to all the nodes along a Z-axis for that node in both the positive and negative directions.
Step 4: Flow data from each node having a value of ‘0’ for their X-coordinate, except the node along the X-axis for the broadcasting node, to all the nodes along an X-axis for that node in the positive direction.

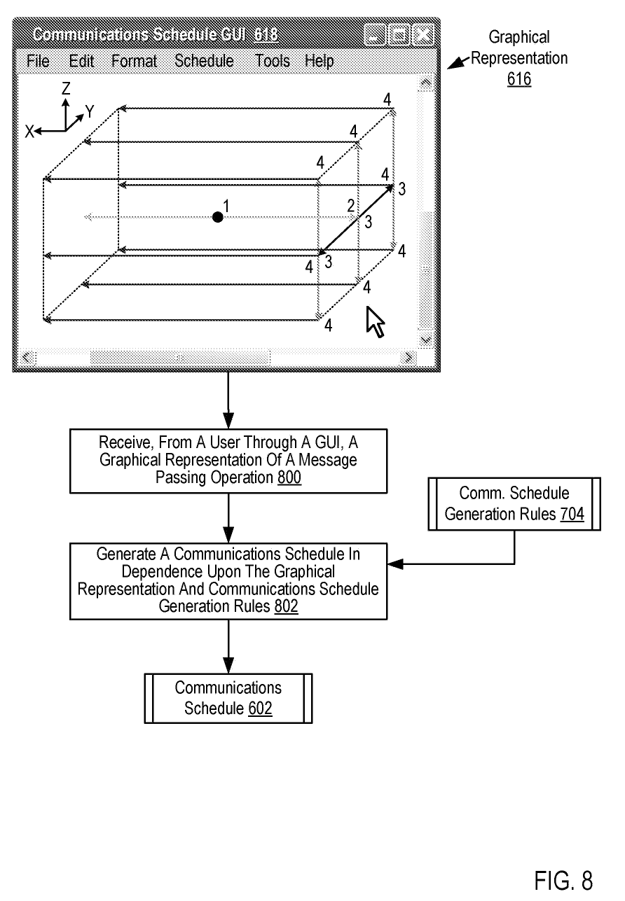

In some embodiments, a user may desire to create a new communications schedule without creating the new communications schedule from an existed communications schedule. For further explanation, FIG. 8 sets forth a flow chart illustrating an exemplary method for creating communications schedules for data communications among compute nodes in a data communications network of a parallel computer according to embodiments of the present invention. The graphical representation (616) of FIG. 8 is the same graphical representation as illustrated in FIG. 6. That is, the exemplary graphical representation (616) of FIG. 8 illustrates a graphical representation of the data flows in a broadcast operation in a torus network. The exemplary graphical representation (616) of FIG. 8 illustrates the torus network as a rectangular box. The links and nodes, except for the broadcasting node (620) are omitted for clarity. Wrap-around links between opposite faces of the rectangular box are also omitted for clarity.

The method of FIG. 8 includes receiving (800), from a user through a graphical user interface (618), a graphical representation (616) of a message passing operation. The graphical representation (616) of FIG. 8 specifies data communications steps in a message passing operation performed by the compute nodes in the data communications network of the parallel computer. Receiving (800), from a user through a graphical user interface (618), a graphical representation (616) of a message passing operation according to the method of FIG. 8 may be carried out by receiving user input that constructs the graphical representation (616) in the GUI (618). The user may provide such input through a variety of user input devices as will occur to those of skill in the art, including a keyboard, mouse, touch-screen, microphone, and so on.

The method of FIG. 8 also includes generating (802) a communications schedule (602) in dependence upon the graphical representation (616) and communications schedule generation rules (704). The communications schedule generation rules (704) of FIG. 8 represent a set of rules used to transform a graphical representation of the data flows for a message passing operation into a communications schedule capable of being executed by or compiled for execution by the compute nodes in a data communications network. Generating (802) a communications schedule (602) according to the method of FIG. 8 may be carried out by applying the communications schedule generation rules (704) to the graphical representation (616) and storing the output as the communications schedule (602). In the example of FIG. 8, applying the communications schedule generation rules (704) to the graphical representation (616) may produce an exemplary communications schedule (616) that is described as follows:
Step 1: Flow data from the broadcasting node to all the nodes along an X-axis for the broadcasting node.
Step 2: Flow data from the node along the X-axis for the broadcasting node and having a value of ‘0’ for the X-coordinate to all the nodes along a Y-axis for that node.
Step 3: Flow data from each node having a value of ‘0’ for their X-coordinate and having the same value for their Z-coordinate as the broadcasting node to all the nodes along a Z-axis for that node.
Step 4: Flow data from each node having a value of ‘0’ for their X-coordinate, except the node along the X-axis for the broadcasting node, to all the nodes along an X-axis for that node.

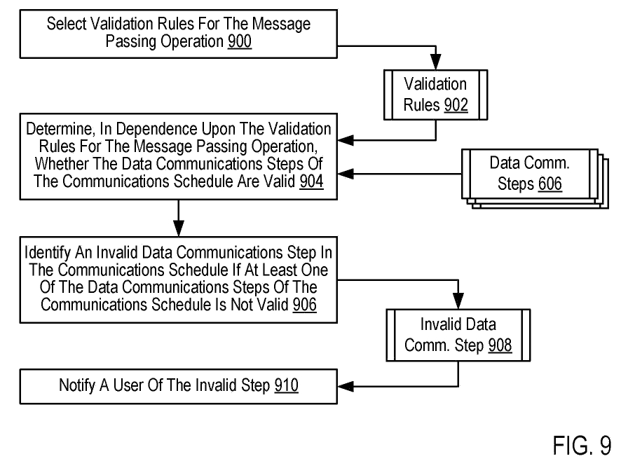

As mentioned above, administering communications schedules for data communications among compute nodes in a data communications network of a parallel computer according to embodiments of the present invention includes parsing a communications schedule to identify the data communications steps. After identifying the data communications steps of a communications schedule, a user may desire to determine whether the data communications steps properly perform the particular message passing operation for which the communications schedule is created. For further explanation, FIG. 9 sets forth a flow chart illustrating a further exemplary method for administering communications schedules for data communications among compute nodes in a data communications network of a parallel computer according to embodiments of the present invention.

The method of FIG. 9 includes selecting (900) validation rules (902) for the message passing operation. Selecting (900) validation rules (902) for the message passing operation according to the method of FIG. 9 may be carried out by receiving a user selection of a particular message passing operation and retrieving, from a repository, the validation rules (902) associated with the particular message passing operation specified by the user selection. For example, a user may desire to validate whether the data communications steps of a particular communications schedule properly instruct the compute nodes to perform a broadcast operation. In such an example, validation rules for a broadcast operation may be selected. For further explanation, consider the following exemplary validation rules for a broadcast operation:
Rule 1: The broadcasting node sends a message.
Rule 2: Each node in the network, except the broadcasting node, must receive the message.
Rule 3: Each node in the network, except the broadcasting node, receives the message only once.

The method of FIG. 9 also includes determining (904), in dependence upon the validation rules (902) for the message passing operation, whether the data communications steps (606) of the communications schedule are valid. Determining (904), in dependence upon the validation rules (902) for the message passing operation, whether the data communications steps (606) of the communications schedule are valid according to the method of FIG. 9 may be carried out by applying the validation rules (902) to the data communications steps (606) to identify whether performing the data communications steps (606) satisfies the validation rules (902). If performing the data communications steps (606) satisfies the validation rules (902), then the data communications steps (606) of the communications schedule are valid. The data communications steps (606) of the communications schedule are not valid, however, if performing the data communications steps (606) does not satisfies the validation rules (902). In the example above, the data communications steps (606) are valid if performing data communications steps (606) the broadcast node injects a message into the network that is receive by all of the nodes, except the broadcasting node, only once.

The method of FIG. 9 also includes identifying (906) an invalid data communications step (908) in the communications schedule if at least one of the data communications steps (606) of the communications schedule is not valid. The invalid data communications step (908) of FIG. 9 represents the data communication step that results in the validation rules (902) not being satisfied when the data communications steps (606) are performed. In many embodiments, validation rules (902) may exist not only at the scope of the communications schedule, but also for the individual data communications steps. Consider, for example, a communications schedule for a broadcast operation. Within the broad scope of the exemplary rule stating that each node in the network, except the broadcasting node, must receive the message, another more finely grained validation rule may require that each node on the X-axis for the broadcasting node receive the message from the broadcasting node. In such embodiments, identifying (906) an invalid data communications step (908) in the communications schedule according to the method of FIG. 9 may be carried out during the process of determining (904) whether the data communications steps (606) of the communications schedule are valid because an invalid step is identified when that particular step does not satisfy validation rules (902) directed toward that particular step. Continuing with the example above, the first data communications step of flowing data from the broadcasting node to all the nodes along an X-axis for the broadcasting node may be identified as an invalid step if, when that first data communications step is performed, each node on the X-axis for the broadcasting node does not receive the message from the broadcasting node.

The method of FIG. 9 includes notifying (910) a user of the invalid step (908). Notifying (910) a user of the invalid step (908) according to the method of FIG. 9 may be carried out by highlighting the invalid step (908) in the communications schedule. In other embodiments, notifying (910) a user of the invalid step (908) according to the method of FIG. 9 may be carried out by displaying a dialog box on a GUI that contains the text of the invalid step (908). In still other embodiments, notifying (910) a user of the invalid step (908) according to the method of FIG. 9 may also be carried out by highlighting the portion of a graphical representation of the communications schedule that corresponds to the invalid data communications step (908).

Exemplary embodiments of the present invention are described largely in the context of a fully functional parallel computer system for creating and administering communications schedules for data communications among compute nodes in a data communications network of a parallel computer. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administering communications schedules for data communications among compute nodes in a data communications network of a parallel computer, the method further comprising:
receiving a communications schedule specifying data communications steps in a message passing operation performed by the compute nodes in the data communications network of the parallel computer;
parsing the communications schedule to identify the data communications steps; and
generating a graphical representation of the communications schedule, including graphing the data communications steps for the message passing operation.

2. The method of claim 1 wherein graphing the data communications steps for the message passing operation further comprising:
assigning a color to one or more of the data communications steps; and
graphing each of the data communications steps in its assigned color.

3. The method of claim 1 further comprising:
selecting validation rules for the message passing operation; and
determining, in dependence upon the validation rules for the message passing operation, whether the data communications steps of the communications schedule are valid.

4. The method of claim 3 further comprising:
identifying an invalid data communications step in the communications schedule if at least one of the data communications steps of the communications schedule is not valid; and
notifying a user of the invalid step.

5. The method of claim 4 wherein notifying a user of the invalid step further comprises highlighting the invalid step in the communications schedule.

6. The method of claim 1 further comprising:
augmenting the graphical representation of the communications schedule for the message passing operation; and
generating a new communications schedule in dependence upon the augmented graphical representation and communications schedule generation rules.

7. The method of claim 1 wherein the parallel computer is comprised of a plurality of compute nodes, the plurality of compute nodes connected for data communications through a plurality of data communications networks, at least one of the data communications networks optimized for point to point operations, and at least one of the data communications networks optimized for collective operations.

8. A method for creating communications schedules for data communications among compute nodes in a data communications network of a parallel computer, the method further comprising:
receiving, from a user through a graphical user interface, a graphical representation of a message passing operation, the graphical representation specifying data communications steps in a message passing operation performed by the compute nodes in the data communications network of the parallel computer; and
generating a communications schedule in dependence upon the graphical representation and communications schedule generation rules.

9. An apparatus for administering communications schedules for data communications among compute nodes in a data communications network of a parallel computer, the apparatus further comprising a computer processor and computer memory operatively coupled to the computer processor, the computer memory having disposed within it computer program instructions capable of:
receiving a communications schedule specifying data communications steps in a message passing operation performed by the compute nodes in the data communications network of the parallel computer;
parsing the communications schedule to identify the data communications steps; and
generating a graphical representation of the communications schedule, including graphing the data communications steps for the message passing operation.

10. The apparatus of claim 9 wherein graphing the data communications steps for the message passing operation further comprising:
assigning a color to one or more of the data communications steps; and
graphing each of the data communications steps in its assigned color.

11. The apparatus of claim 9 wherein the computer memory also has disposed within it computer program instructions capable of:
selecting validation rules for the message passing operation; and
determining, in dependence upon the validation rules for the message passing operation, whether the data communications steps of the communications schedule are valid.

12. The apparatus of claim 11 wherein the computer memory also has disposed within it computer program instructions capable of:
identifying an invalid data communications step in the communications schedule if at least one of the data communications steps of the communications schedule is not valid; and
notifying a user of the invalid step.

13. A computer program product for administering communications schedules for data communications among compute nodes in a data communications network of a parallel computer, the computer program product disposed upon a computer readable medium, the computer program product comprising computer program instructions capable of:
receiving a communications schedule specifying data communications steps in a message passing operation performed by the compute nodes in the data communications network of the parallel computer;
parsing the communications schedule to identify the data communications steps; and
generating a graphical representation of the communications schedule, including graphing the data communications steps for the message passing operation.

14. The computer program product of claim 13 wherein graphing the data communications steps for the message passing operation further comprising:
assigning a color to one or more of the data communications steps; and
graphing each of the data communications steps in its assigned color.

15. The computer program product of claim 13 further comprising computer program instructions capable of:
selecting validation rules for the message passing operation; and
determining, in dependence upon the validation rules for the message passing operation, whether the data communications steps of the communications schedule are valid.

16. The computer program product of claim 15 further comprising computer program instructions capable of:
identifying an invalid data communications step in the communications schedule if at least one of the data communications steps of the communications schedule is not valid; and
notifying a user of the invalid step.

17. The computer program product of claim 16 wherein notifying a user of the invalid step further comprises highlighting the invalid step in the communications schedule.

18. The computer program product of claim 13 further comprising computer program instructions capable of:
augmenting the graphical representation of the communications schedule for the message passing operation; and
generating a new communications schedule in dependence upon the augmented graphical representation and communications schedule generation rules.

19. The computer program product of claim 13 wherein the computer readable medium comprises a recordable medium.

20. The computer program product of claim 13 wherein the computer readable medium comprises a transmission medium.
